(19) United States
(12) Patent Application Publication
(10) Pub. No.: US 2008/0235484 A1
(43) Pub. Date: Sep. 25, 2008

(54) Method and System for Host Memory Alignment

(76) Inventors: Uri Tal, Netanya (IL); Eliezer Aloni, Zur Yigal (IL); Shay Mizrachi, Hod HaSharon (IL); Kobby Carmona, Hod HaSharon (IL)

Correspondence Address: MCANDREWS HELD & MALLOY, LTD, 500 WEST MADISON STREET, SUITE 3400, CHICAGO, IL, 60661, US

(21) Appl. No.: 12/052,878

(22) Filed: Mar. 21, 2008

Related U.S. Application Data
(60) Provisional application No. 60/896,302, filed on Mar. 22, 2007.

(51) Int. Cl. G06F 12/02

(52) U.S. Cl. 711/201; 711/E12.002

(57) ABSTRACT

Certain aspects of a method and system for host memory alignment may include splitting a received read and/or write I/O request at a first of a plurality of memory cache line boundaries to generate a first portion of the received I/O request. A second portion of the received read and/or write I/O request may be split into a plurality of segments so that each of the plurality of segments is aligned with one or more of the plurality of memory cache line boundaries. A cost of memory bandwidth for accessing host memory may be minimized based on the splitting of the second portion of the received read and/or write I/O request.

### CROSS-REFERENCE TO RELATED APPLICATIONS/INCORPORATION BY REFERENCE

This application makes reference to, claims priority to, and claims benefit of U.S. Provisional Application Ser. No. 60/896,302, filed Mar. 22, 2007.

The above stated application is hereby incorporated herein by reference in its entirety.

### FEDERALLY SPONSORED RESEARCH OR DEVELOPMENT

Not Applicable

### MICROFICHE/COPYRIGHT REFERENCE

Not Applicable

### FIELD OF THE INVENTION

Certain embodiments of the invention relate to memory management. More specifically, certain embodiments of the invention relate to a method and system for host memory alignment.

### BACKGROUND OF THE INVENTION

In recent years, the speed of networking hardware has increased by a couple of orders of magnitude, enabling packet networks such as Gigabit Ethernet™ and InfiniBand™ to operate at speeds in excess of about 1 Gbps. Network interface adapters for these high-speed networks typically provide dedicated hardware for physical layer and medium access control (MAC) layer processing (Layers 1 and 2 in the Open Systems Interconnect model). Some newer network interface devices are also capable of offloading upper-layer protocols from the host CPU, including network layer (Layer 3) protocols, such as the Internet Protocol (IP), and transport layer (Layer 4) protocols, such as the Transport Control Protocol (TCP) and User Datagram Protocol (UDP), as well as protocols in Layers 5 and above.

Chips having LAN on motherboard (LOM) and network interface card capabilities are already on the market. One such chip comprises an integrated Ethernet transceiver (up to 1000 BASE-T) and a PCI or PCI-X bus interface to the host computer and offers the following exemplary upper-layer facilities: TCP offload engine (TOE), remote direct memory access (RDMA), and Internet small computer system interface (iSCSI). The TOE offloads much of the computationally-intensive TCP/IP tasks from a host processor onto the NIC, thereby freeing up host processor resources.

A RDMA controller (RNIC) works with applications on the host to move data directly into and out of application memory without CPU intervention. RDMA runs over TCP/IP in accordance with the iWARP protocol stack. RDMA uses remote direct data placement (RDDP) capabilities with IP transport protocols, in particular with SCTP, to place data directly from the NIC into application buffers, without intensive host processor intervention. The RDMA protocol utilizes high speed buffer to buffer transfer to avoid the penalty associated with multiple data copying. An iSCSI controller emulates SCSI block storage protocols over an IP network. Implementations of the iSCSI protocol may run over either TCP/IP or over RDMA, the latter of which may be referred to as iSCSI extensions over RDMA (iSER).

In systems such as the one described above, hardware and software may often be used to support asynchronous data transfers between two memory regions in data network connections, often on different systems. Each host system may serve as a source (initiator) system which initiates a message data transfer (message send operation) to a target system of a message passing operation (message receive operation). Examples of such a system may include host servers providing a variety of applications or services and I/O units providing storage oriented and network oriented I/O services. Requests for work, for example, data movement operations including message send/receive operations and remote direct memory access (RDMA) read/write operations may be posted to work queues associated with a given hardware adapter, the requested operation may then be performed. It may be the responsibility of the system which initiates such a request to check for its completion. In order to optimize use of limited system resources, completion queues may be provided to coalesce completion status from multiple work queues belonging to a single hardware adapter. After a request for work has been performed by system hardware, notification of a completion event may be placed on the completion queue. The completion queues may provide a single location for system hardware to check for multiple work queue completions.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for host memory alignment, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary system for host memory alignment, in accordance with an embodiment of the invention.

FIG. 1B is a block diagram of another exemplary system for host memory alignment, in accordance with an embodiment of the invention.

FIG. 2 is a diagram of illustrating an exemplary alignment of memory, in accordance with an embodiment of the invention.

FIG. 3 is a diagram of an exemplary memory alignment and boundary constraint, in accordance with an embodiment of the invention.

FIG. 4 is a diagram illustrating exemplary splitting of requests for host memory alignment, in accordance with an embodiment of the invention.

FIG. 5 is a diagram illustrating exemplary splitting of requests for host memory alignment, in accordance with an embodiment of the invention.

### DETAILED DESCRIPTION OF THE INVENTION

Certain aspects of the invention may be found in a method and system for host memory alignment. Exemplary aspects of the invention may comprise splitting a received read and/or write I/O request at a first of a plurality of memory cache line boundaries to generate a first portion of the received I/O request. A second portion of the received read and/or write I/O request may be split into a plurality of segments so that each of the plurality of segments is aligned with one or more of the plurality of memory cache line boundaries. A cost of memory bandwidth for accessing host memory may be minimized based on the splitting of the second portion of the received read and/or write I/O request.

Next generation Ethernet LANs may operate at wire speeds up to 10 Gbps or even greater. As a result, the LAN speed may approach the internal bus speed of the hosts that are connected to the LAN. For example, the PCI Express® (also referred to as “PCI-Ex”) bus in the widely-used 8X configuration operates at 16 Gbps, meaning that the LAN speed may be more than half the bus speed. For a network interface chip to support communication at the full wire speed, while also performing protocol offload functions, the chip may not only operate rapidly, but also make efficient use of the host bus. In particular, the bus bandwidth that is used for conveying connection state information between the chip and host memory may be reduced as far as possible. In other words, the chip may be designed for high-speed, low-latency protocol processing while minimizing the volume of data that it sends and receives over the bus and the number of bus operations that it uses for this purpose.

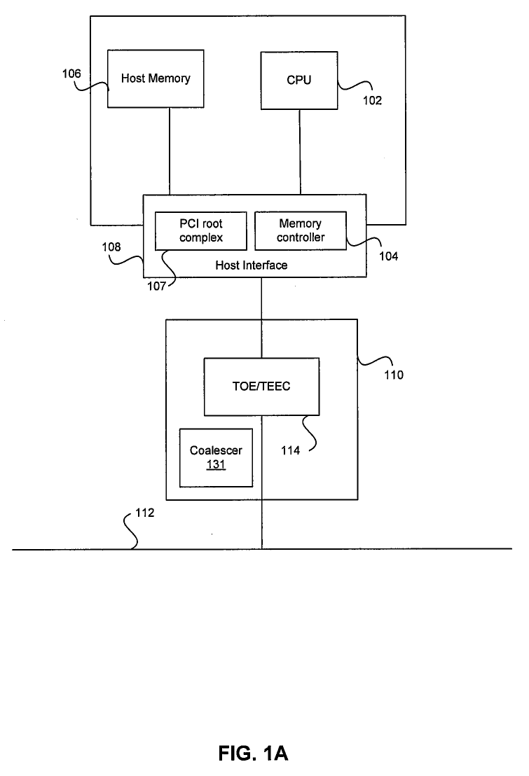

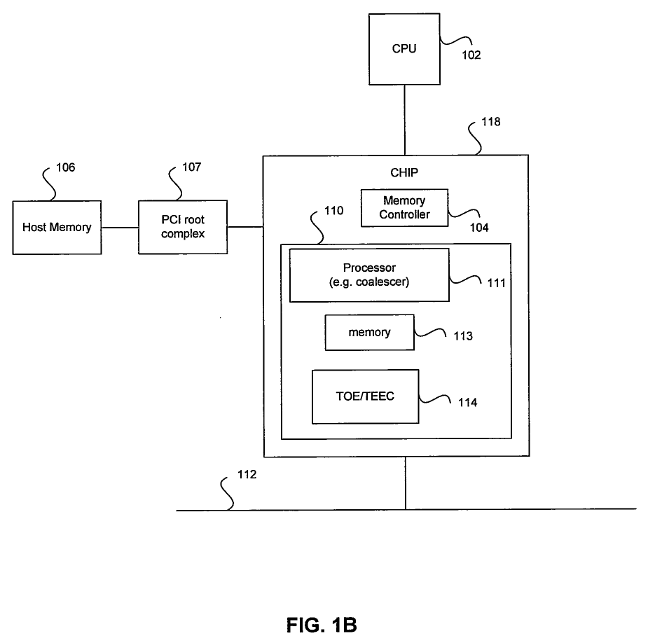

FIG. 1A is a block diagram of an exemplary system for host memory alignment, in accordance with an embodiment of the invention. Referring to FIG. 1A, the system may comprise, for example, a CPU 102, a host memory 106, a host interface 108, network subsystem 110 and an Ethernet bus 112. The network subsystem 110 may comprise, for example, a TCP-enabled Ethernet Controller (TEEC) or a TCP offload engine (TOE) 114 and a coalescer 131. The network subsystem 110 may comprise, for example, a network interface card (NIC). The host interface 108 may be, for example, a peripheral component interconnect (PCI), PCI-X, PCI-Express, ISA, SCSI or other type of bus. The host interface 108 may comprise a PCI root complex 107 and a memory controller 104. The host interface 108 may be coupled to PCI buses and/or devices, one or more processors, and memory, for example, host memory 106. Notwithstanding, the host memory 106 may be directly coupled to the network subsystem 110. In this case, the host interface 108 may implement the PCI root complex functionally and may be coupled to PCI buses and/or devices, one or more processors, and memory. The memory controller 106 may be coupled to the CPU 104, to the memory 106 and to the host interface 108. The host interface 108 may be coupled to the network subsystem 110 via the TEEC/TOE 114. The coalescer 131 may be enabled to aggregate a plurality of bytes of incoming TCP segments that have been placed to the host memory 106 but have not yet been delivered to a user application.

FIG. 1B is a block diagram of another exemplary system for host memory alignment, in accordance with an embodiment of the invention. Referring to FIG. 1B, the system may comprise, for example, a CPU 102, a host memory 106, a dedicated memory 116 and a chip 118. The chip 118 may comprise, for example, the network subsystem 110 and the memory controller 104. The chip set 118 may be coupled to the CPU 102 and to the host memory 106 via the PCI root complex 107. The PCI root complex 107 may enable the chip 118 to be coupled to PCI buses and/or devices, one or more processors, and memory, for example, host memory 106. Notwithstanding, the host memory 106 may be directly coupled to the chip 118. In this case, the host interface 108 may implement the PCI root complex functionally and may be coupled to PCI buses and/or devices, one or more processors, and memory. The network subsystem 110 of the chip 118 may be coupled to the Ethernet 112. The network subsystem 110 may comprise, for example, the TEEC/TOE 114 that may be coupled to the Ethernet bus 112. The network subsystem 110 may communicate to the Ethernet bus 112 via a wired and/or a wireless connection, for example. The wireless connection may be a wireless local area network (WLAN) connection as supported by the IEEE 802.11 standards, for example. The network subsystem 110 may also comprise, for example, an on-chip memory 113. The dedicated memory 116 may provide buffers for context and/or data.

The network subsystem 110 may comprise a processor such as a coalescer 111. The coalescer 111 may be enabled to aggregate a plurality of bytes of incoming TCP segments that have been placed to the host memory 106 but have not yet been delivered to a user application. Although illustrated, for example, as a CPU and an Ethernet, the present invention need not be so limited to such examples and may employ, for example, any type of processor and any type of data link layer or physical media, respectively. Accordingly, although illustrated as coupled to the Ethernet 112, the TEEC or the TOE 114 of FIG. 1A may be adapted for any type of data link layer or physical media. Furthermore, the present invention also contemplates different degrees of integration and separation between the components illustrated in FIGS. 1A-B. For example, the TEEC/TOE 114 may be a separate integrated chip from the chip set 118 embedded on a motherboard or may be embedded in a NIC. Similarly, the coalescer 111 may be a separate integrated chip from the chip set 118 embedded on a motherboard or may be embedded in a NIC. In addition, the dedicated memory 116 may be integrated with the chip set 118 or may be integrated with the network subsystem 110 of FIG. 1B.

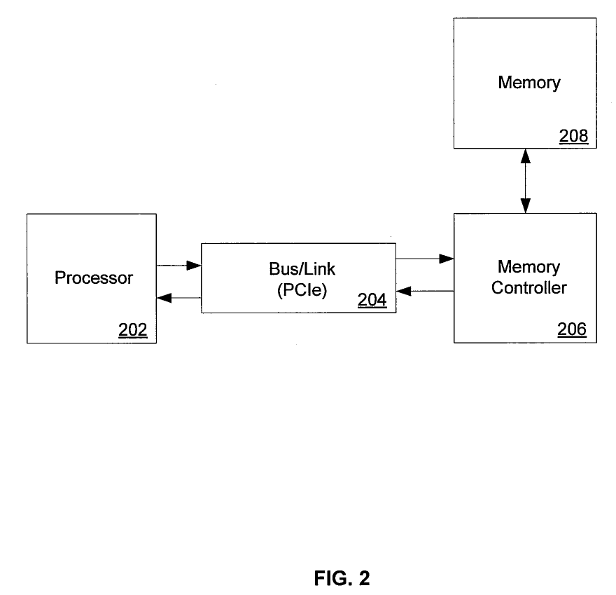

FIG. 2 is a block diagram of an exemplary system for host memory alignment, in accordance with an embodiment of the invention. Referring to FIG. 2, there is shown a processor 202, a bus/link 204, a memory controller 206 and a memory 208.

The processor 202 may be, for example, a storage processor, a graphics processor, a USB processor or any other suitable type of processor. The bus/link 204 may be a Peripheral Component Interconnect Express (PCIe) bus, for example. The processor 202 may be enabled to receive a plurality of data segments and place one or more received data segments into pre-allocated host data buffers. The processor 202 may be enabled to write the received data segments into one or more buffers in the memory 208 via the PCIe bus 204, for example. The received data segments maybe TCP/IP segments, iSCSI segments, RDMA segments or any other suitable network data segments, for example. The processor 202 may be enabled to generate a completion queue element (CQE) to memory 208 when a particular buffer in memory 208 is full. The processor 202 may be enabled to notify the driver 37 about placed data segments. The memory controller 206 may be enabled to perform preliminary buffer management and network processing of the plurality of data segments.

In accordance with an embodiment of the invention, the processor 202 may be enabled to initiate read and write operations toward the memory 208. These read and/or write requests may be relayed via the PCIe bus 204 and the memory controller 206. The read operations may be followed by a read completion notification returned to the processor 202. The write operations may not require any completion notification.

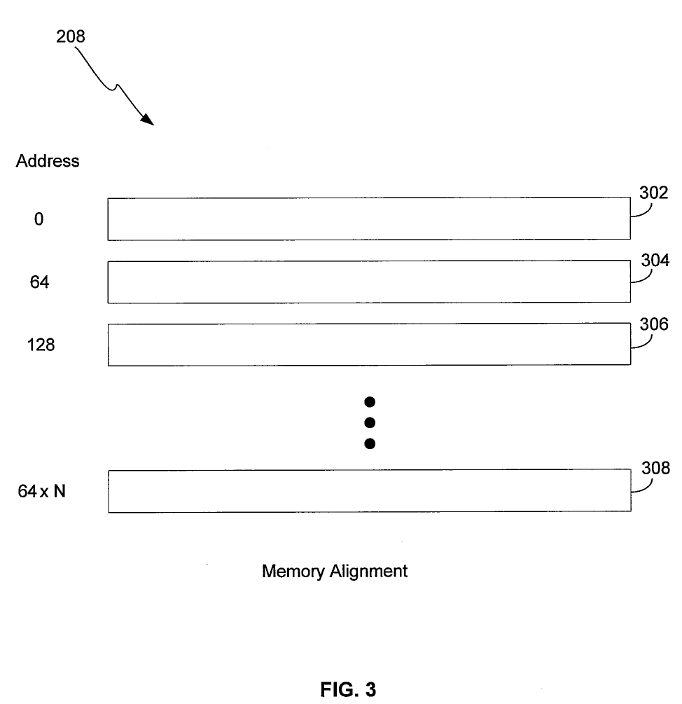

FIG. 3 is a diagram of illustrating an exemplary alignment of memory, in accordance with an embodiment of the invention. Referring to FIG. 3, there is shown an exemplary memory 208.

The memory 208 may comprise a plurality of memory cache lines of size 64 bytes each, for example, 302, 304, 306 . . . 308. In one embodiment of the invention, the interface between the memory controller 206 and the memory 208 may have a data width of 64 or 128 bits (8 or 16 bytes, respectively), for example. Other bus widths may be utilized without departing from the scope and/or various aspects of the invention. Notwithstanding, the memory 208 may be accessed in bursts, and the minimum burst length for a read and/or write operation may be 64 bytes, for example. Notwithstanding, the invention may not be so limited and other burst length sizes may be utilized without departing from the scope of the invention. Accordingly, the memory 208 may be organized in memory lines of 64 bytes each.

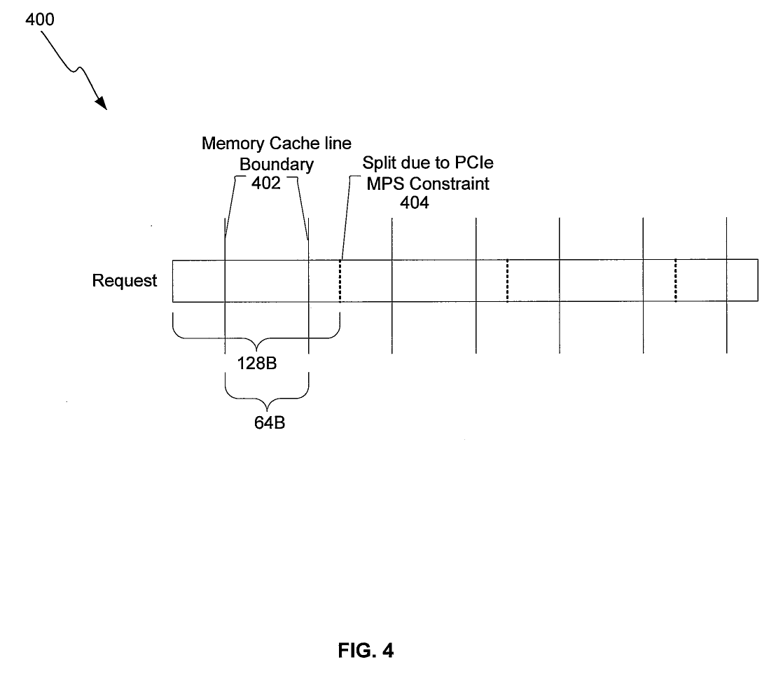

FIG. 4 is a diagram of an exemplary memory alignment and boundary constraint, in accordance with an embodiment of the invention. Referring to FIG. 4, there is shown a request 400. The request 400 may be a read and/or write request, for example.

Each memory cache line 402 may be 64 bytes, for example. Each write request may be split into a plurality of segments of size equal to a maximum payload size (MPS) 404. The MPS 404 may be 128 bytes, 256 bytes, . . . , 4096 bytes, for example, depending on system configuration. Each read request may be split into a plurality of segments of size equal to a maximum read request size (MRRS) 404. The MRRS 404 may also be 128 bytes, 256 bytes, . . . , 4096 bytes, for example, depending on system configuration. In an exemplary embodiment of the invention, the MPS=MRRS=128 bytes, for example. Notwithstanding, the invention is not so limited and other values, whether greater or smaller may be utilized without departing from the scope of the invention.

Table 1 illustrates cost of memory bandwidth at the interface between the memory controller 206 and the memory 208 for a plurality of alignment scenarios. In this table, “R” represents cost of memory bandwidth for one 64-byte read operation, and “W” represents cost of memory bandwidth for one 64-byte write operation.

TABLE 1

| | Cost of memory bandwidth |
|---|---|
| DMA Operation | on memory interface |
| 64-byte aligned read of | m * R |
| 64 * m bytes | |
| 64-byte aligned write of | m * W |
| 64 * m bytes | |
| Read of m bytes, m < 64, not | R |
| crossing 64-byte boundary | |
| Read of m bytes, non- | (K + 1) * R |
| aligned to 64-bytes, crossing | |
| K 64-byte boundary | |
| Write of m bytes, m < 64, not | R, W (read-modify-write) |
| crossing 64-byte boundary | |
| Write of m bytes, non | (K − 1) * W + 2 * (R + W) |
| aligned to 64 bytes, and | |
| crossing K 64-byte | |
| boundaries | |

As illustrated in Table 1, non-aligned accesses, and particularly non-aligned writes may incur a significant penalty on the memory interface. Additionally, the PCIe bus 204 may impose further constraints that may entail further decrease in memory 208 utilization.

Table 2 illustrates cost of memory bandwidth at the interface between the memory controller 206 and the memory 208 for a plurality of alignment scenarios incorporating PCIe boundary constraints. In one embodiment of the invention, it may be assumed that the size of a memory cache line is 64 bytes, for example, and MPS=MRRS=128 bytes, for example.

TABLE 2

| | | Cost of memory bandwidth |
|---|---|---|
| | Cost of memory bandwidth | on memory interface, |
| | on memory interface, | PCIe split into |
| DMA Operation | no PCIe split | MPS = MRRS = 128 B |
| 64-byte aligned read of | m * R | m * R |
| 64 * m bytes | | |
| 64-byte aligned write of | m * W | m * W |
| 64 * m bytes | | |
| Read of m bytes, m < 64, not | R | R |
| crossing 64-byte | | |
| boundary | | |
| Read of m bytes, non- | (K + 1) * R | ~ 1.5 * K * R |
| aligned to 64-bytes, | | |
| crossing K 64-byte | | |
| boundary | | |
| Write of m bytes, m < 64, | R, W (read-modify-write) | R, W |
| not crossing 64-byte | | |
| boundary | | |
| Write of m bytes, non | (K − 1) * W + 2 * (R + W) | ~ (K/2) * W + K * (R, W) |
| aligned to 64 bytes, and | | |
| crossing K 64-byte | | |
| boundaries | | |

In accordance with an embodiment of the invention, the memory controller 206 may not have to aggregate several split PCIe transactions. The memory controller 206 may be unaware of the split on the PCIe level, and may treat each request from the PCIe bus 204 as a distinct request. Accordingly, a read request that may be non-aligned to 64 byte boundaries and is split into m 128 byte segments may result in 3*m 64 byte read cycles on the memory interface, instead of 2*m 64 byte read cycles for aligned access. Similarly, a write request that may be non-aligned to 64 byte boundaries and is split into m 128 byte segments may result in 2*m 64 byte read cycles and 3*m 64 byte write cycles, instead of 2*m 64 byte write cycles for aligned access.

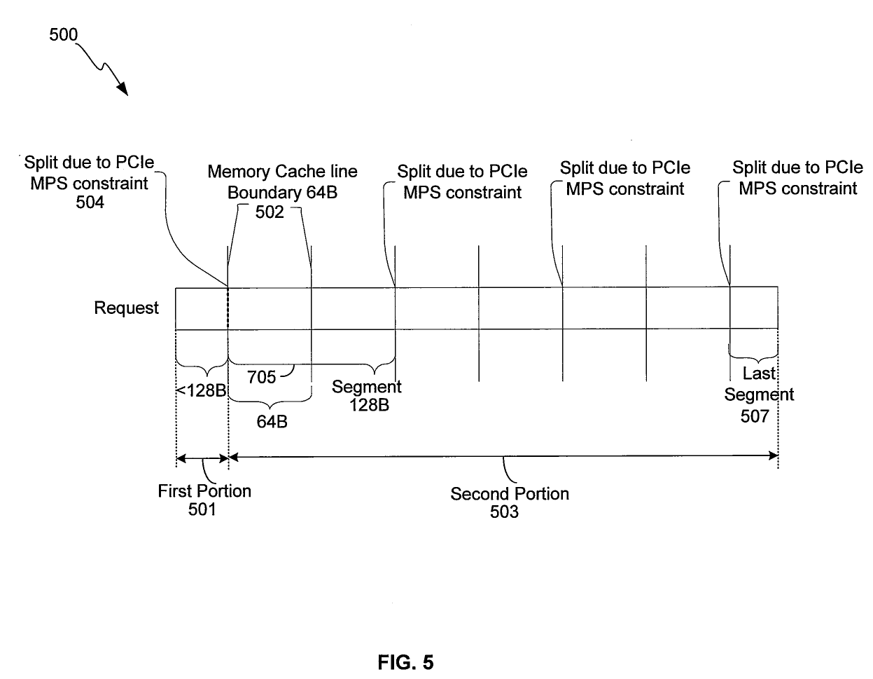

FIG. 5 is a diagram illustrating exemplary splitting of requests for host memory alignment, in accordance with an embodiment of the invention. Referring to FIG. 5, there is shown a request 500. The request 500 may be a read and/or write request, for example.

Each memory cache line 502 may be 64 bytes, for example. Each write request may be split into a plurality of segments of size equal to a maximum payload size (MPS) 504. The MPS 504 may be 128 bytes, 256 bytes, . . . , 4096 bytes, for example, depending on system configuration. Each read request may be split into a plurality of segments of size equal to a maximum read request size (MRRS) 504. The MRRS 504 may also be 128 bytes, 256 bytes, . . . , 4096 bytes, for example, depending on system configuration. In an exemplary embodiment of the invention, the MPS=MRRS=128 bytes, for example. Notwithstanding, the invention is not so limited and other values, whether greater or larger may be utilized without departing from the scope of the invention.

The received read and/or write I/O request 500 may be split at a first of a plurality of memory cache line boundaries 502 to generate a first portion 501 of the received I/O request 500. A second portion 503 of the received I/O request 500 maybe split based on a PCIe bus constraint 504 into a plurality of segments, for example, segment 505 so that each of the plurality of segments is aligned with one or more of the plurality of memory cache line boundaries 502. A cost of memory bandwidth for accessing host memory 508 may be minimized based on the splitting of the second portion 503 of the received I/O request 500. The size of each of the plurality of memory cache line boundaries 502 may be 64 bytes, for example. The processor 202 may be enabled to place the received I/O request 500 at an offset within a memory buffer so that the offset is aligned with one or more of the plurality of memory cache line boundaries 502. The processor 202 may be enabled to notify a driver of the offset within the memory buffer along with the aggregated plurality of completions. In one embodiment of the invention, the order of sending completions of received I/O requests 500 to a host may be different than the order of processing the received I/O requests 500 in the memory 208. For example, the first generated portion 501 may be accessed in the last received I/O request 500.

In accordance with an embodiment of the invention, the cost of memory bandwidth for accessing host memory 208 that may be incurred by non-aligned accesses to the memory 208 due to the PCIe bus split constraints 504 may be minimized. Accordingly, the request 500 may be split such that only the first and last segments may be non-aligned, and the rest of the segments may be aligned with the memory cache line boundaries 502. For example, if the first segment is of size ([-start_address] mod 64) then the rest of the segments may begin at a 64 byte aligned addresses. For a non-aligned write request operation of size is 64*K bytes, the cost of memory bandwidth on memory interface may be (K+2)*(R, W) at the maximum, for example.

In accordance with an embodiment of the invention, a plurality of completions associated with the received I/O request 500 may be aggregated to an integer multiple of the size of each of the plurality of memory cache line boundaries 502, for example, 64 bytes prior to writing to a host 102. For transmitted requests, it may not be possible to address alignment issues, because transmit requests may be issued via application buffers that may not be aligned to a fixed boundary. For connection context regions, non-alignment may be eliminated by aligning every context region, for example. The buffer descriptors that may be read from host memory 208 may be read in, for example, 64 byte segments to preserve the alignment.

In accordance with another embodiment of the invention, in cases where connection context regions comprising data structures may be accessed only by the processor 202 and may not be utilized by the host CPU 102, the size of the data structures may be rounded up to an integer multiple of the memory cache line boundaries 502, for example, and may be aligned to the memory cache line boundaries 502. In accordance with another embodiment of the invention, in cases where data elements that may be written to an array are smaller than the memory cache line boundaries 502, then the size of the data element may be a power of two, for example. In another embodiment of the invention, the array base may be aligned to the memory cache line boundaries 502 so that none of the data elements are written across a memory cache line boundary 502. In another embodiment of the invention, the processor 202 may be enabled to aggregate the received I/O requests 500, for example, read and/or write requests of the data elements so that the read and/or write requests are an integer multiple of the data elements and the address of the received I/O request 500 is aligned to the memory cache line boundaries 502. For example, a plurality of completions of a write I/O request or a plurality of buffer descriptors of a read I/O request may be aggregated to an integer multiple of the data elements.

In accordance with an embodiment of the invention, a method and system for host memory alignment may comprise a processor 202 that enables splitting of a received I/O request 500 at a first of a plurality of memory cache line boundaries 502 to generate a first portion 501 of the received I/O request 500. The processor 202 may be enabled to split a second portion 503 of the received I/O request 500 based on a bus constraint 504 into a plurality of segments, for example, segment 505 so that each of the plurality of segments is aligned with one or more of the plurality of memory cache line boundaries 502. A cost of memory bandwidth for accessing host memory 508 may be minimized based on the splitting of the second portion 503 of the received I/O request 500.

The received I/O request 500 may be a read request and/or a write request. The bus may be a Peripheral Component Interconnect Express (PCIe) bus 204. The processor 202 may enable splitting of the second portion 503 of the received I/O request 500 into 128 byte segments based on the PCIe bus split constraints 504. The size of each of the plurality of memory cache line boundaries 502 may be 64 bytes, 128 bytes and/or 256 bytes, for example. The processor 202 may enable aggregation of a plurality of completions associated with the received I/O request 500 to an integer multiple of the size of each of the plurality of memory cache line boundaries 502, for example, 64 bytes prior to writing to a host 102. The processor 202 may be enabled to place the received I/O request 500 at an offset within a memory buffer so that the offset is aligned with one or more of the plurality of memory cache line boundaries 502. The processor 202 may be enabled to notify a driver of the offset within the memory buffer along with the aggregated plurality of completions. In one embodiment, the generated first portion 501 of the received I/O request 500 and the last segment 507 of the plurality of segments may not be aligned with the plurality of memory cache line boundaries 502. The processor 202 may enable aggregation of a plurality of buffer descriptors associated with a received read I/O request 500 to an integer multiple of the size of each of the plurality of memory cache line boundaries 502, for example, 64 bytes. The processor 202 may be enabled to round up a size of a plurality of data structures utilized by the processor 202 to an integer multiple of the memory cache line boundaries 502 so that each of the plurality of data structures is aligned with one or more of the plurality of memory cache line boundaries 502. The processor 202 may be enabled to align a start address of an array comprising a plurality of data elements to one of the plurality of memory cache line boundaries 502, wherein a size of the array is less than a size of each of the plurality of memory cache lines 302, for example, 64 bytes. The split I/O requests may be communicated to the host in order or out of order. For example, split I/O requests may be communicated to the host in a different order than the order of the processing of the split I/O requests within the received I/O request 500.

Certain embodiments of the invention may comprise a machine-readable storage having stored thereon, a computer program having at least one code section for host memory alignment, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing data, the method comprising:
splitting a received I/O request at a first of a plurality of memory cache line boundaries to generate a first portion of said received I/O request; and
splitting a second portion of said received I/O request into a plurality of segments so that each of said plurality of segments is aligned with one or more of said plurality of memory cache line boundaries.

2. The method according to claim 1, wherein said received I/O request is a read request.

3. The method according to claim 1, wherein said received I/O request is a write request.

4. The method according to claim 1, comprising splitting said second portion of said received I/O request into said plurality of segments based on a bus constraint.

5. The method according to claim 4, wherein said bus is a Peripheral Component Interconnect Express (PCIe) bus.

6. The method according to claim 1, comprising aggregating a plurality of completions associated with said received I/O request to an integer multiple of a size of each of said plurality of memory cache lines prior to writing to a host.

7. The method according to claim 6, comprising placing said received I/O request at an offset within a memory buffer so that said offset is aligned with said one or more of said plurality of memory cache line boundaries.

8. The method according to claim 7, comprising notifying a driver of said offset within said memory buffer along with said aggregated plurality of completions.

9. The method according to claim 8, comprising aggregating a plurality of buffer descriptors associated with a read I/O request to an integer multiple of said size of each of said plurality of memory cache lines.

10. The method according to claim 1, comprising rounding up a size of a plurality of data structures utilized by a processor receiving said I/O request to an integer multiple of said memory cache line boundaries so that each of said plurality of data structures is aligned with one or more of said plurality of memory cache line boundaries.

11. The method according to claim 1, comprising aligning a start address of an array comprising a plurality of data elements to one of said plurality of memory cache line boundaries, wherein a size of said array is less than a size of each of said plurality of memory cache lines.

12. The method according to claim 1, comprising communicating a plurality of said split received I/O requests to a host in order or out of order.

13. A system for processing data, the system comprising:
one or more circuits that enables splitting of a received I/O request at a first of a plurality of memory cache line boundaries to generate a first portion of said received I/O request; and
said one or more circuits enables splitting of a second portion of said received I/O request into a plurality of segments so that each of said plurality of segments is aligned with one or more of said plurality of memory cache line boundaries.

14. The system according to claim 13, wherein said received I/O request is a read request.

15. The system according to claim 13, wherein said received I/O request is a write request.

16. The system according to claim 13, wherein said one or more circuits enables splitting of said second portion of said received I/O request into said plurality of segments based on a bus constraint.

17. The system according to claim 16, wherein said bus is a Peripheral Component Interconnect Express (PCIe) bus.

18. The system according to claim 1, wherein said one or more circuits enables aggregation of a plurality of completions associated with said received I/O request to an integer multiple of a size of each of said plurality of memory cache lines prior to writing to a host.

19. The system according to claim 18, wherein said one or more circuits enables placement of said received I/O request at an offset within a memory buffer so that said offset is aligned with said one or more of said plurality of memory cache line boundaries.

20. The system according to claim 19, wherein said one or more circuits enables notification to a driver of said offset within said memory buffer along with said aggregated plurality of completions.

21. The system according to claim 20, wherein said one or more circuits enables aggregation of a plurality of buffer descriptors associated with a read I/O request to an integer multiple of said size of each of said plurality of memory cache lines.

22. The system according to claim 13, wherein said one or more circuits enables rounding up of a size of a plurality of data structures utilized by a processor receiving said I/O request to an integer multiple of said memory cache line boundaries so that each of said plurality of data structures is aligned with one or more of said plurality of memory cache line boundaries.

23. The system according to claim 13, wherein said one or more circuits enables alignment of a start address of an array comprising a plurality of data elements to one of said plurality of memory cache line boundaries, wherein a size of said array is less than a size of each of said plurality of memory cache lines.

24. The system according to claim 13, wherein said one or more circuits enables communication of a plurality of said split received I/O requests to a host in order or out of order.
